(19) United States
(12) Patent Application Publication
(10) Pub. No.: US 2013/0164091 A1
(43) Pub. Date: Jun. 27, 2013

(54) APPARATUS AND METHOD FOR MANUFACTURING LED LIGHT BARS

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/610,869

(22) Filed: Sep. 12, 2012

(30) Foreign Application Priority Data
Dec. 26, 2011 (TW) 100148724

(51) Int. Cl. B23C 3/00; B23Q 11/00; B23C 9/00

(52) U.S. Cl. 409/132; 409/228; 409/137

(57) ABSTRACT

A method for manufacturing LED light bars including steps: providing an LED light board comprising a first LED light bar, a second LED light bar and a connecting bridge interconnecting the first and second LED light bars; then providing a milling cutter and a retaining portion, wherein the milling cutter rotates and moves frontward to cut the connecting bridge along a side surface of the first LED light bar, and the retaining portion moves together with the milling cutter and keeps pressing against the side surface of the first LED light bar during cutting of the milling cutter to the connecting bridge. The retaining portion has a plurality of inhaling holes defined therein, which are used for sucking dust into the retaining portion during the cutting operation of the milling cutter to the connecting bridge.

### TECHNICAL FIELD

The present disclosure relates to LED (light emitting diode) light bars, and more particularly, to a method and apparatus for manufacturing the LED light bars.

### DESCRIPTION OF RELATED ART

LEDs (Light-Emitting Diodes) have many advantages, such as high luminosity, low operational voltage, low power consumption, compatibility with integrated circuits, easy driving, long term reliability, and environmental friendliness. Such advantages have promoted the wide use of LEDs as a light source. Nowadays, LED lamps are commonly applied in general lighting. Generally, the LED lamp may include one or several straight LED light bars for producing a desired illumination. An LED light bar includes an elongated printed circuit board and a plurality of LEDs linearly mounted on the printed circuit board. During mounting the LEDs on the printed circuit board, the printed circuit board is required to have a sufficient rigidity for preventing deformation thereof; otherwise, deviation of the LEDs from the target positions on the printed circuit board may be resulted. Therefore, the printed circuit boards of the LED light bars are connected by some connecting bridges to increase rigidity thereof before and during mounting the LEDs on the printed circuit boards. After mounting of the LEDs, the printed circuit boards need to be separated from each other to form individual LED light bars. Generally, the printed circuit boards are separated from each other by using milling cutters to cut away the connecting bridges between adjacent LED light bars. However, due to high speed rotation of the milling cutter, a side of the LED light bar will be attracted by the rotating milling cutter, thereby causing an excessive cutting of the side of the printed circuit board of the LED light bar, i.e., a recess being formed in the side of the LED bar. Such an excessive cutting may damage the LED light bar and affect normal operation of the LED light bar.

What is needed, therefore, is an LED light bar manufacturing apparatus and method which can overcome the described limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is schematic, top view of LED light bars to be separated from each other by a cutting apparatus and method in accordance with an embodiment of the present disclosure, wherein the LED light bars are connected together by bridges.

FIG. 2 is a schematic, partially enlarged top view showing the cutting apparatus to cut one of the bridges interconnecting two neighboring ones of the LED light bars of FIG. 1.

FIG. 3 is a cross sectional view, viewed from a front aspect, showing the cutting apparatus and the two interconnected LED bars of FIG. 2.

FIG. 4 is a cross sectional view, viewed from a lateral side aspect, showing the cutting apparatus, the bridge and one of the two interconnected LED light bars of FIG. 2.

### DETAILED DESCRIPTION

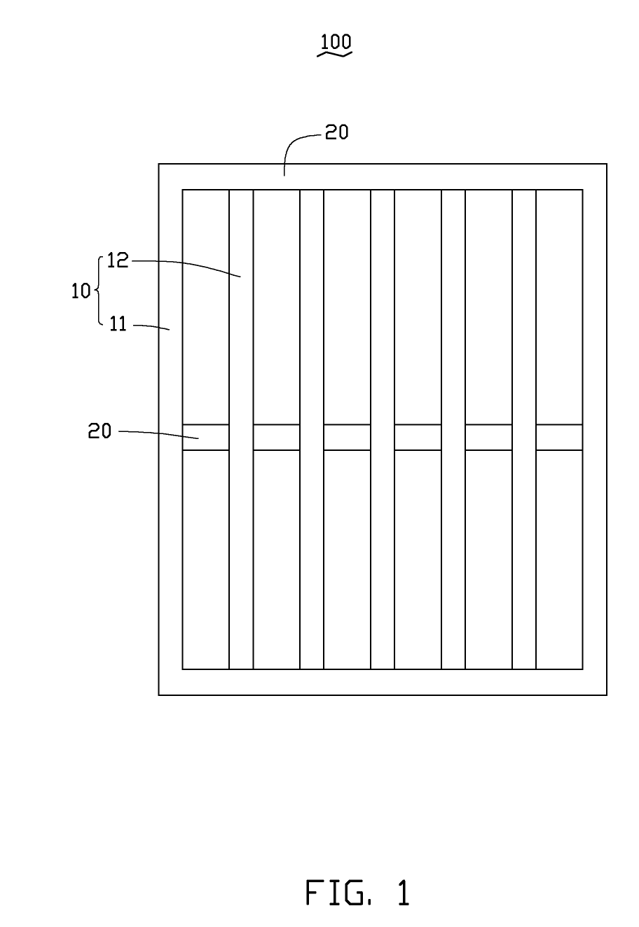

Referring to FIG. 1, a light board 100 to be cut to form a plurality of LED light bars 10 in accordance with an embodiment of the present disclosure is shown. The light board 100 includes several strip-shaped light bars 10. The LED light bars 10 are parallel to each other. Every two adjacent LED light bars 10 are connected together by a connecting bridge 20 therebetween. The connecting bridges 20 are used to increase the strength of the LED light bars 10 and therefore ensure precise mounting of LEDs (not shown) on printed circuit boards (not shown) of the LED light bars 10. In this embodiment, the connecting bridges 20 connect ends and middles of the LED light bars 10. A left-most LED light bar 10 is termed as a first LED light bar 11, and an LED light bar 10 adjacent to the first LED light bar 11 is termed as a second LED light bar 12, for facilitating the description of the present disclosure. Three connecting bridges 20 connect two adjacent ends, another two adjacent ends and two middles of the first LED light bar 11 and the second LED light bar 12, respectively. Detailed processes to cut away the connecting bridges 20 interconnecting the first LED light bar 11 and the second LED light bar 12 will be discussed below in details.

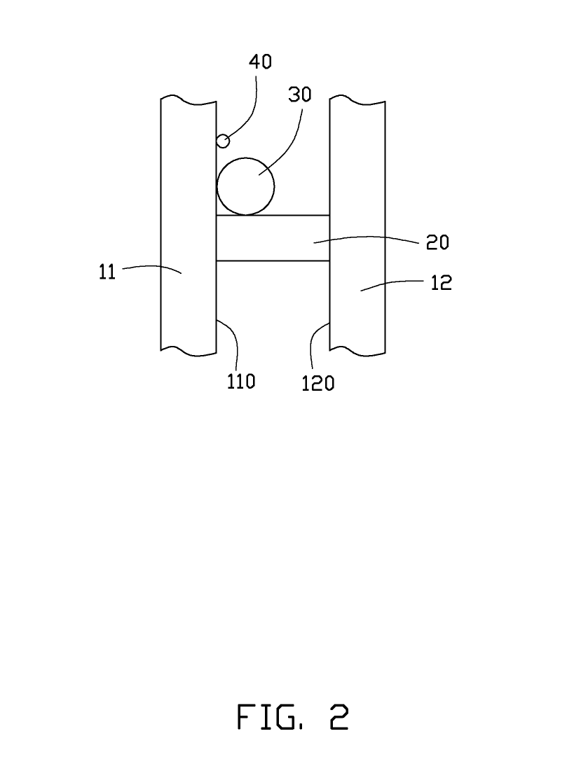

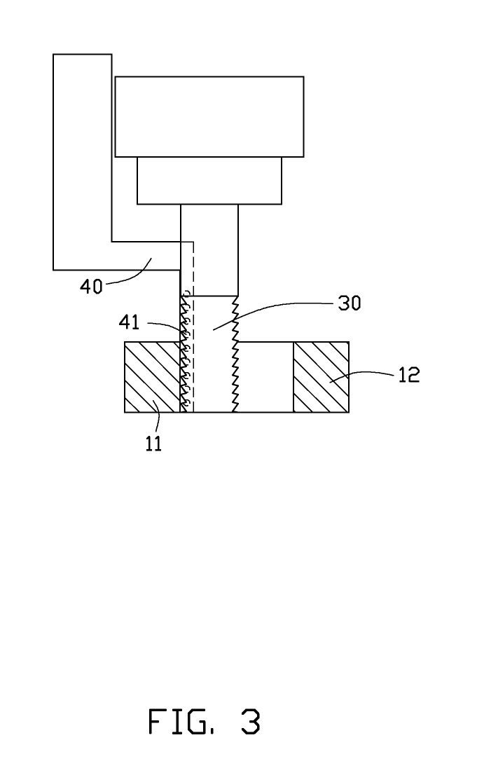

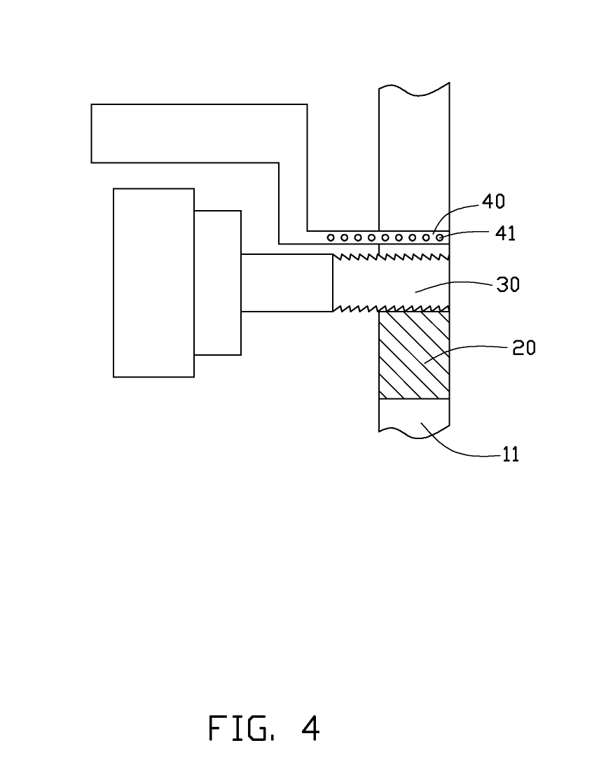

Referring to FIGS. 2-4, a cutting apparatus is provided. The first LED light bar 11 includes a flat right surface 110. The second light bar 12 includes a flat left surface 120. The connecting bridges 20 connect the right surface 110 and the left surface 120. The cutting apparatus includes a milling cutter 30. A diameter of the milling cutter 30 is smaller than a length of the connection bridge 20. The milling cutter 30 includes a number of spiral blades on its peripheral surface. The spiral blades rotate at a high speed along a counter-clockwise direction and form a cutting force to cut the connecting bridges 20. The milling cutter 30 moves frontward along the right surface 110 of the first LED light bar 10 to cut away the connecting bridges 20. A retaining portion 40 which connects with the milling cutter 30 constantly abuts against the right surface 110 of the first LED light bar 11 during the cutting operation of the mailing cutter 30 to the connecting bridge 20. A diameter of the retaining portion 40 is smaller than that of the milling cutter 30. In this embodiment, the retaining portion 40 is behind the milling cutter 30 (shown in FIG. 2). The retaining portion 40 constantly abuts against the right surface 110 during the cutting operation. The retaining portion 40 is a hollow tube having a circular cross-section. A plurality of inhaling holes 41 are uniformly distributed in an outer circumferential surface of the retaining portion 40. The retaining portion 40 connects with a vacuum cleaner (not shown) in order to suck dust via the holes 41, wherein the dust is generated by the cutting operation of the milling cutter 30 to the connecting bridge 20. Due to the retaining portion 40 is near the milling cutter 30, the cleaning holes 41 can suck dust produced by cutting the connecting bridges 20 simultaneously.

The milling cutter 30 rotates and moves frontward to cut the connecting bridges 20. The retaining portion 40 moves together with the milling cutter 30. Though the milling cutter 30 has a trend to attract the first LED light bar 11 when the milling cutter 30 is rotating to cut the connecting bridges 20, the retaining portion 40 which abuts against the right surface 110 of the first LED light bar 11 all the time prevents such attraction of the first LED light bar 11 to the milling cutter 30. Thus, the first light bar 11 is protected from an excessive cutting thereto by the milling cutter 30. After cutting along the right side 110 of the first LED light bar 11, the milling cutter 30 returns and moves backward along the left surface 120 of the second LED light bar 12, to thereby cut the connecting bridges 20 remained on the left surface 120. Finally, the connecting bridges 20 which connect the first light bar 11 and the second light bar 12 are completely cut away, whereby the first LED light bar 11 which now is in an individual form is obtained.

Because the milling cutter 30 rapidly rotates, dust will be produced during the cutting of the connecting bridges 20. Due to the retaining portion 40 includes inhaling holes 41, the dust can be instantly removed during the whole cutting progress. On the premise of not affecting the rotation of the milling cutter 30, the retaining portion 40 should be located from the milling cutter 30 as close as possible, thereby to obtain the optimal dust removing effectiveness and flatness of the side surfaces of the LED light bars 10.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A method for manufacturing LED light bars comprising:
providing an LED light board comprising a first LED light bar, a second LED light bar adjacent to the first LED light bar, and a connecting bridge interconnecting the first LED light bar and the second LED light bar; and
providing a milling cutter and a retaining portion which is movable synchronously with a movement of the milling cutter;
rotating and moving the milling cutter to cut away the connecting bridge along a side surface of the first LED light bar, during which the retaining portion moves together with the milling cutter and keeps abutting against the side surface of the first LED light bar.

2. The method of claim 1, wherein after cutting the connecting bridge from the side surface of the first LED light bar, the milling cutter keeps rotating and moves in a reversed direction to cut the connecting bridge from an opposite side surface of the second LED light bar.

3. The method of claim 1, wherein the retaining portion is a hollow tube and has several inhaling holes defined in an outer circumferential face thereof for sucking dusts generated by the cutting of the milling cutter to the connecting bridge.

4. The method of claim 3, wherein the retaining portion has a circular cross-section.

5. The method of claim 4, wherein the cleaning holes are uniformly distributed in the outer circumferential surface of the retaining portion.

6. The method of claim 3, wherein the retaining portion is configured for connecting with a vacuum cleaner.

7. The method of claim 1, wherein a diameter of the milling cutter is smaller than a length of the connecting bridge.

8. The method of claim 7, wherein a diameter of the retaining portion is smaller than that of the milling cutter.

9. The method of claim 1, wherein the side surface of the first LED light bar is flat.

10. The method of claim 1, wherein the side surface of the second LED light bar is flat.

11. The method of claim 1, wherein the retaining portion is located beside the milling cutter.

12. An apparatus for cutting a connecting bridge interconnecting two LED light bars, comprising:
a milling cutter which is rotated and moved through the connecting bridge to cut away the connecting bridge; and
a retaining portion which is movable synchronously with the movement of the milling cutter, being configured for in constant contact with a side surface of one of the LED light bars during the cutting of the milling cutter to a portion of the connecting bridge which protrudes from the side surface of the one of the LED light bars.

13. The apparatus of claim 12, wherein the retaining portion defines a plurality of holes therein for sucking dust into the retaining portion, the dust being produced by the cutting of the milling cutter to the connecting bridge.
